(19) United States
(12) Patent Application Publication
(10) Pub. No.: US 2023/0196947 A1
(43) Pub. Date: Jun. 22, 2023

(54) METALENS, METALENS SET AND METHOD OF IMAGE CONSTRUCTION OR DECRYPTION THEREOF

(71) Applicant: Broadray Technology Co. Ltd., Zhubei City (TW)

(72) Inventor: Vin-Cent Su, Zhubei City (TW)

(21) Appl. No.: 17/557,195

(22) Filed: Dec. 21, 2021

(51) Int. Cl. G09C 1/00; G02B 3/02

(52) U.S. Cl. CPC G09C 1/00; G02B 3/02

(57) ABSTRACT

A metalens, a metalens set, and a method of image construction or decryption are disclosed. The metalens includes metastructures each having a shape and a height related to a resonant light wavelength of the metastructure, so that the metalens can present an incident light of the resonant light wavelength as a light shape or light pattern at a far-field position matching the resonant light wavelength. A metalens set formed by staking the metalenses vertically can present incident lights having different resonant wavelengths as light shapes, light patterns, or resolved images at far-field positions matching the resonant wavelengths. Image construction or decryption are achieved by combining resolved images of the resonant light wavelengths with non-resolved images of non-resonant light wavelengths so as to compose an overlay image, which is to be decomposed by the metalens or the metalens set so as to recover the resolved images.

### BACKGROUND OF THE INVENTION

### 1. Technical Field

The present invention relates to optical lenses, more particularly to a metalens and a method of using a metalens set, for the construction of resolved images at far-field positions matching light wavelengths resonated by the metalens or metalens set (also referred to as resonant light wavelengths herein) or the decryption of an image at focus positions of the resonant light wavelengths.

### 2. Description of Related Art

Lenses are optical elements extensively used in daily life and particularly form essential parts in smartphones, glasses and microscopes, for example. However, applications of lenses can be limited by their optical properties endowed by the natural materials and their design principles. For instance, chromatic aberration can narrow working wavebands of lenses and make the resulting devices bulky. While metasurfaces allow optical structures to be microminiaturized in design, problems of chromatic aberration caused by color dispersion remain unaddressed.

To solve the foregoing problems, studies have been conducted and published as papers in many scholarly journals. For example, a paper entitled “Broadband Achromatic Optical Metasurface Devices” was published in the Nature Communications on Aug. 4, 2017, with a filed patent application therefor entitled as “Broadband achromatic metalens in the visible spectrum” (hereinafter referred to as the “prior-art patent”) and laid open under the publication number of U.S. Pat. No. 11,079,520B2, whose related application in Taiwan has been granted with patent rights under the U.S. Pat. No. 1,696,297.

As disclosed in the summary of the prior-art patent, in an optical component comprising an array of metalenses, each of the metalenses has a dielectric layer and a plurality of nanostructures disposed on the dielectric layer. Each of the nanostructures comprises an array of first phase-compensation structures, and an array of second phase-compensation structures. The array of the first phase-compensation structures is disposed to surround the array of the second phase-compensation structures so as to define a single metalens. The first and second phase-compensation structures are complementary to each other and substantially satisfy the Babinet's principle.

The conclusion of the prior-art patent states that the broadband achromatic metalens utilizes a series of GaN-based resonance units to operate in the visible light spectrum. Combined with the PB phase method and integrated resonance, the achromatic metalens can have a phase profile as required. The test results such as a USAF analysis test confirmed that the prior-art optical component has full-color imaging performance. The results of experimental examples demonstrated the widest frequency range in which the achromatic metalens operates in the visible light spectrum. It is worth noting that this translucent visible achromatic metalens is the most advanced technology. Due to its miniaturized size, the prior-art achromatic metalens may be used to form a lens array applied to light field cameras for achromatic imaging. At last, the low costs and compatibility with semiconductor manufacturing processes allow the metalens and the resulting optical components to be applied to nanophotonics in the visible light spectrum range and to be used as integrated optical components.

However, benefits of metalenses should be far beyond applications of eliminating chromatic aberration caused by color dispersion. It is thus envisaged that novel metastructures that independently form individual metalens or jointly form a metalens set could present specific designed patterns associated with incident light at far-field positions matching resonant light wavelengths they are designed for, and could be applied to more scenes, such as structured light and time of flight (TOF) for 3D sensing. Even more, the characteristics of metalenses about chromatic dispersion could be leveraged to process images according to particular requirements. For example, images can be an effective means to express and communicate messages, but people are concerned for issues about privacy and security because there is a risk that images carrying important messages, if not well protected, could be accessed by unauthorized parties. For ensuring secure image transmission, there is obviously a need for a development of new, secure image-transmitting method. By using chromatic dispersion properties of metalenses to secure access and decryption of images, the application scope of metalenses is expected to be further extended.

### SUMMARY OF THE INVENTION

In view of the shortcomings of the prior art, the present invention provides a metalens that presents a light shape or a light pattern of a resonant light wavelength at a far-field position matching the respective resonant light wavelength. Further, plural such metalenses having different resonant light wavelengths may be combined in to a metalens set that resonates lights of different wavelengths, so as to present light shapes or light patterns at the far-field positions matching the respective resonant light wavelengths. Even more, such a metalens set or individual metalenses can be used to decrypt an encrypted image composed of resolved images of resonant light wavelengths and non-resolved images of non-resonant light wavelengths by presenting resolved images at far-field positions matching the respective resonant light wavelengths, respectively. This further extends the application scope of metalenses.

The present invention provides a metalens, which includes a substrate and a metastructure layer. The metastructure layer carries a plurality of metastructures, each of which has a shape designed to be related to the resonant light wavelength (λ) of the metastructure. The interval between adjacent metastructures is about a half of the resonant light wavelength of the metastructure, with an interval tolerance of ±30%, and preferably of ±1˜10%. The height of metastructure is up to three times of the resonant light wavelength of the metastructure, with a height tolerance of ±30%, and preferably of ±1˜10%. When an incident light passes through the metalens, a light shape or a light pattern will be presented at a far-field position matching the resonant light wavelength.

Therein, each of the metastructures has a phase distribution that follows the equation below:

φ(r,θ)=k\sqrt{r²+f²+lθ}
where, r represents the relative polar coordinate with respect to the center of the surface of the metastructure layer, f represents the distance from the focal length of the metalens to the center of the surface of the substrate, θ represents the azimuthal angle, l represents the topological number of the angular momentum, and k represents the wave vector, so that the metalens can provide a vortical light shape at a far-field position matching the resonant light wavelength.

Therein, each of the metastructures has a phase distribution that follows the equation below:

$$φ ( x , y ) = \frac{2 π}{λ} ( f - \sqrt{{x}^{2} + {y}^{2} + {f}^{2}} )$$

where, x and y are relative coordinates with respect to the origin at the center of the metastructure layer, f represents the distance from the focal length of the metalens to the center of the surface of the substrate, and λ represents the light wavelength of the resolved light source, so that the metalens can present an image at a far-field position matching the resonant light wavelength.

The present invention provides a metalens set, which includes plural metalenses. The metalenses are arranged or stacked into arrays so as to present resolved light source patterns of different light wavelengths at different far-field positions.

The present invention provides a method of image decryption, which includes the following step: receiving incident lights from different sources so that the incident lights after passing through the metalens or the metalens set are presented as light shapes or patterns at far-field positions matching the resonant light wavelengths.

Therein, the incident light sources form an overlay image that is composed of resolved images of the resonant light wavelengths of the metalenses or the metalens set and of plural non-resolved images not of the resonant light wavelengths of the metalenses or the metalens set. The overlay image after passing through the metalenses or the metalens set is presented as resolved images at matching far-field positions.

Accordingly, the metalenses designed to resonate different light wavelengths can present light shapes or light patterns at matching far-field positions. Since a metalens set combines metalenses designed to resonate different light wavelengths, it can present resolved light sources of different wavelengths at far-field positions matching the respective light wavelengths, thereby realizing high-resolution, complicated resolved images.

### BRIEF DESCRIPTION OF THE DRAWINGS

FIG. 1 is a partial, enlarged schematic drawing of a metalens.

FIG. 2 is an image of the center area of the metalens obtained using SEM (Scanning Electron Microscope) photography.

FIG. 3 is an image of the edge area of the metalens obtained using SEM photography.

FIG. 3-1 is an image of the metastructure layer having a vortical light pattern obtained using OM (Optical Microscope) photography.

FIG. 4 is a schematic view of images of different light wavelengths presented by the metalens at different far-field positions.

FIG. 4-1 is a schematic drawing of another metalens set.

FIG. 4-2 is a schematic drawing of still another metalens set.

FIG. 5 is a vortical light shape output by metastructures having a phase distribution that follows Equation (2).

FIG. 6 shows a schematic structure in which a metalens set decrypts an overlay image projected by a projector.

FIG. 7 shows an overlay image received by a metalens set of the present invention.

FIG. 8 experimentally shows a red image component of the overlay image of FIG. 7 presented at the focal length of the red light wavelength.

FIG. 9 experimentally shows a green image component of the overlay image of FIG. 7 presented at the focal length of the green light wavelength.

FIG. 10 experimentally shows a blue image component of the overlay image of FIG. 7 presented at the focal length of the blue light wavelength.

FIG. 11 shows another overlay image received by the metalens set of the present invention.

FIG. 12 experimentally shows a red image component of the overlay image of FIG. 11 presented at the focal length of the red light wavelength.

FIG. 13 experimentally shows a green image component of the overlay image of FIG. 11 presented at the focal length of the green light wavelength.

FIG. 14 experimentally shows a blue image component of the overlay image of FIG. 11 presented at the focal length of the blue light wavelength.

FIG. 15 shows still another overlay image received by the metalens set of the present invention.

FIG. 16 experimentally shows a red image component of the overlay image of FIG. 15 presented at the focal length of the red light wavelength.

FIG. 17 experimentally shows a green image component of the overlay image of FIG. 15 presented at the focal length of the green light wavelength.

FIG. 18 experimentally shows a blue image component of the overlay image of FIG. 15 presented at the focal length of the blue light wavelength.

### DETAILED DESCRIPTION OF THE INVENTION

The following detailed specific embodiments when read with the accompanying drawings are made to clearly exhibit the above-mentioned and other objectives, technical schemes, and advantages of the present invention. However, these embodiments are intended for reference and illustration, but not to limit the present invention.

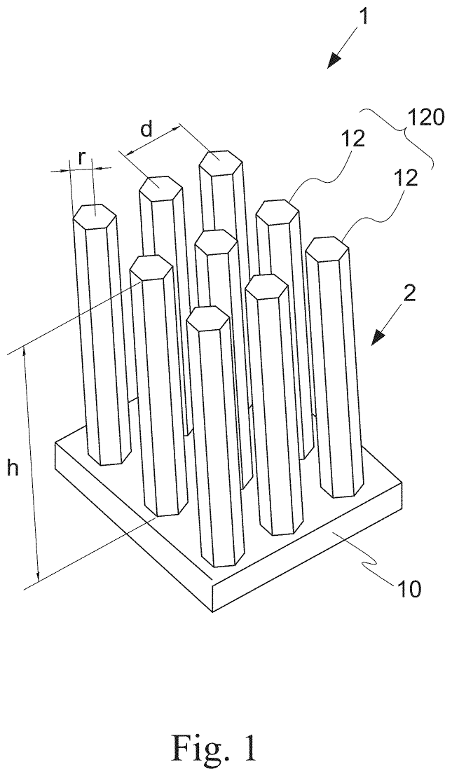

The present invention provides a metalens. As shown in FIG. 1, the metalens 1 includes a substrate 10 and a metastructure layer 12. The substrate 10 is made of a dielectric material, a metal material, or a composite material containing both dielectric and metal. For example, the dielectric material may be sapphire. The metastructure layer 12 includes a plurality of metastructures 120. The shape and size of each metastructure 120 are related to the light wavelength resonated by the metastructure 120. An incident light passing through the metalens is presented as a light shape or light pattern at a far-field position matching the resonant light wavelengths.

In the present invention, the shape and size of each metastructure 120 are such related to its resonant light wavelength that the surface area of the metastructure 120 is related to the resonant light wavelength, and the height of the metastructure 120 is related to the resonant light wavelength, while the intervals between adjacent metastructures 120 is related to the resonant light wavelength.

Further, the height of each metastructure 120 is up to three times of the resonant light wavelength, and the height tolerance of each metastructure is ±30%. For example, assuming that the light wavelength that a metastructure 120 resonates is 500 nm, the maximum height of the metastructure 120 can be 1500 nm. Furthermore, if a metastructure has a height of 1500 nm, and the tolerance is ±10%, the height of the metastructure may range between 1350 and 1650 nm.

Moreover, the interval d between adjacent metastructures 120 is equal to a half of the resonant light wavelength, and the interval tolerance is ±30%. For example, assuming that the light wavelength the metastructures 120 resonate is 100 nm, the interval between the metastructures 120 is 50 nm. Given that the tolerance is ±10%, the interval between the metastructures 120 can range between 45 and 55 nm.

Furthermore, the radius of the surface area of each metastructure 120 is smaller than or equal to a half of the interval d, and the radius tolerance is +30%. For example, if the interval between the metastructures 120 is 500 nm, given that the radius tolerance is ±10%, the radius of the surface area of the metastructure 120 can be smaller than or equal to ranging between 225 and 275 nm.

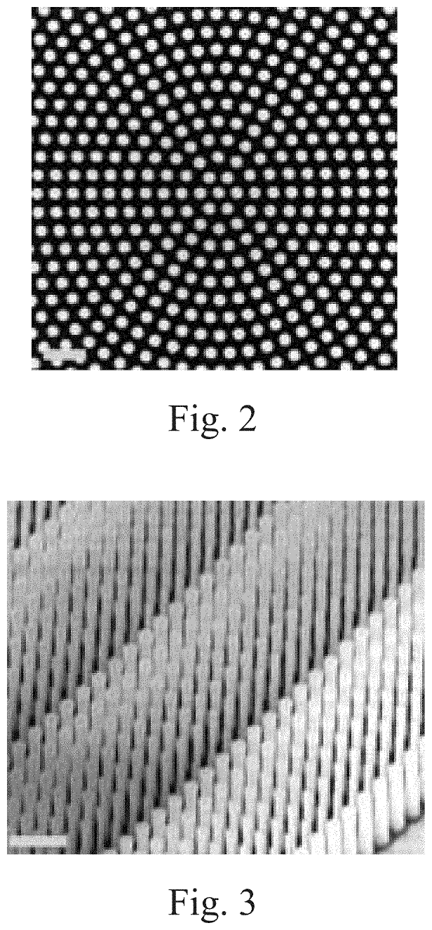

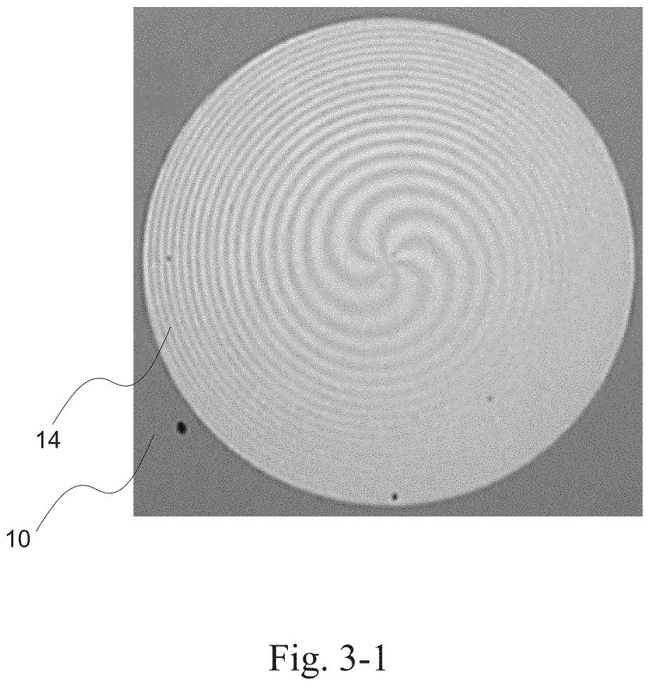

In the present invention, as shown in FIG. 2-3, the metastructures 120 are arranged on the substrate 10. Each metastructure 120 is a hexagonal prism, which forms a hexagon-resonated element (or HRE). The metastructures 120 may be made of gallium nitride (GaN), but implementation of the present invention is not limited thereto. The metastructures 120 may be polyhedrons instead of the hexagonal prisms as mentioned previously. Alternatively, the metastructures 120 may be made of a material other than GaN. Arrangement of the metastructures 120 may be triclinic, monoclinic, orthorhombic, tetragonal, hexagonal, trigonal or isometric, as defined in crystal lattice systems. In other words, any configuration of the metastructures 120 that can provide the light shape(s) or light pattern(s) or resolved image(s) at matching far-field positions is embraced by the present invention.

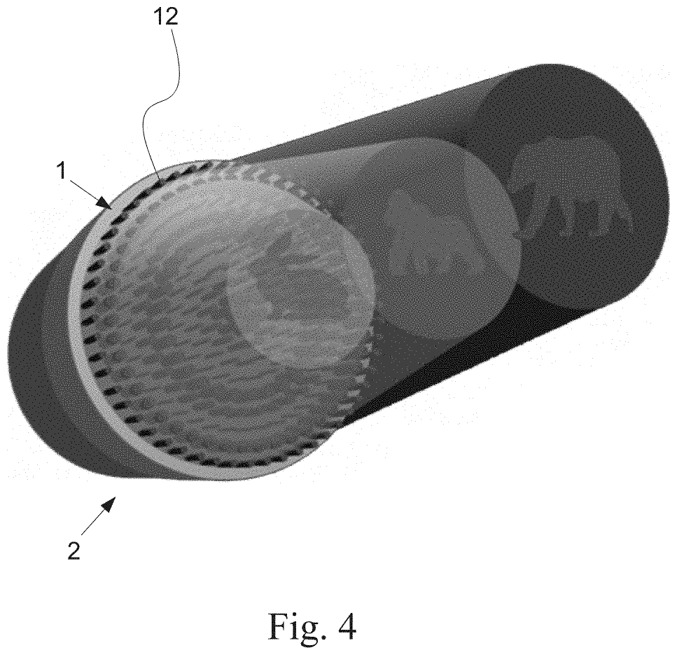

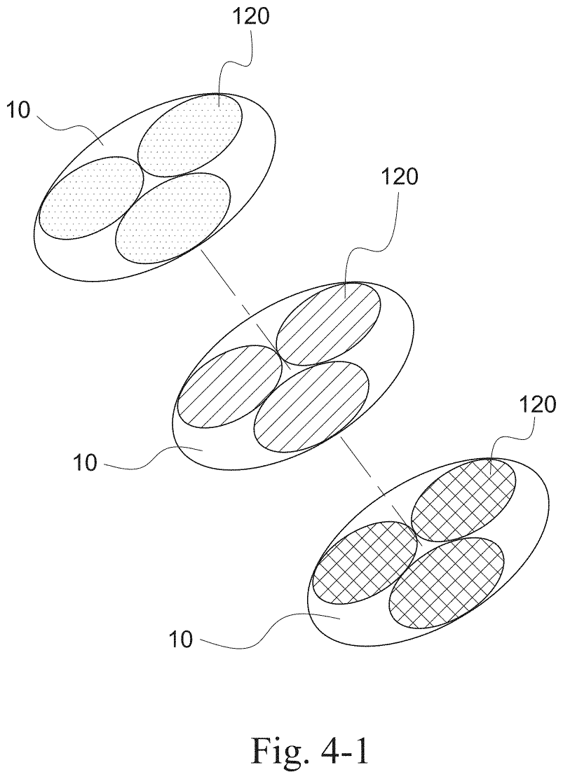

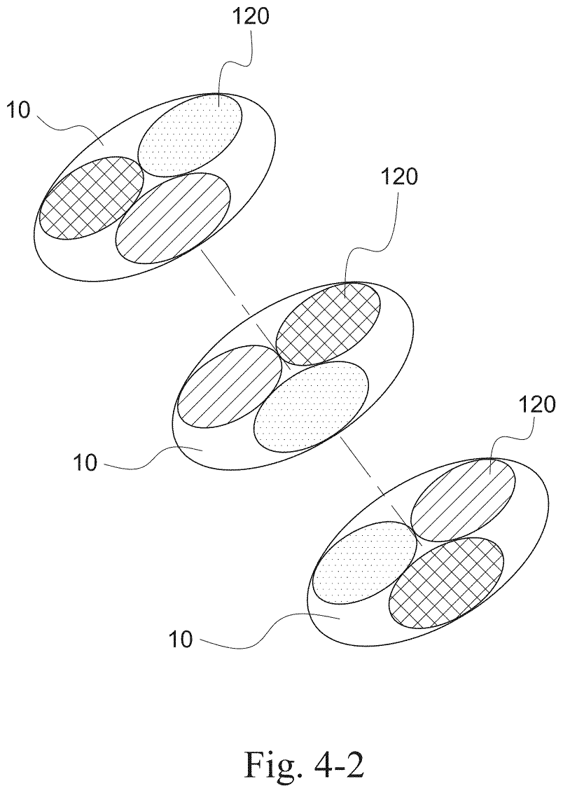

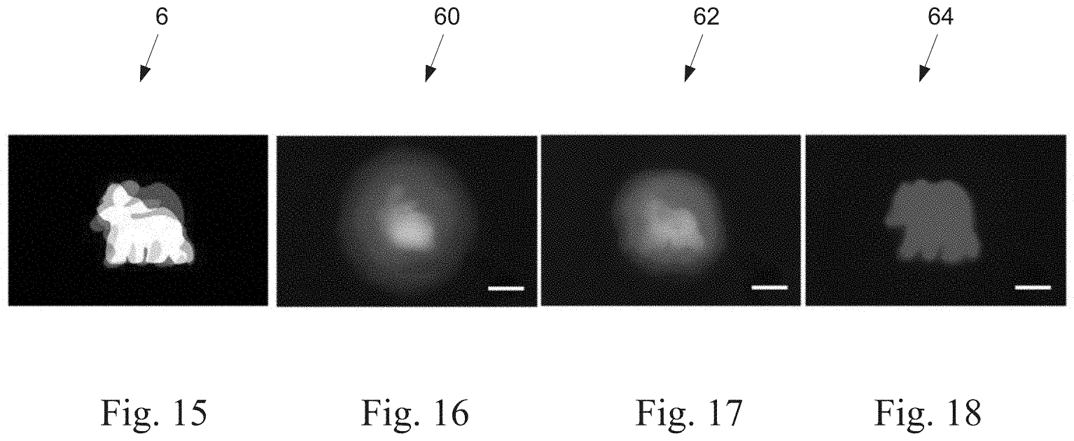

In the present invention, each metastructure 120 has a phase distribution that follows Equation (1):

$$φ ( x , y ) = \frac{2 π}{λ} ( f - \sqrt{{x}^{2} + {y}^{2} + {f}^{2}} ) \qquad Equation ( 1 )$$

where, x and y are relative coordinates with respect to the origin at the center of the substrate 10, f represents the distance from the focal length of the metalens to the center of the metastructure layer 12, and λ represents the light wavelength of the resolved light source, so that the metalens presents a pattern of the resonant light wavelength at the matching far-field position (as shown in FIG. 4). In an example where the incident light source is the red rabbit image shown in FIG. 4 and the resonant light wavelength of the metalens is the red light wavelength, since this phase distribution does not change the light shape, a red rabbit image 60 as shown in FIG. 15 is presented at a far-field position matching the metalens.

In the present invention, as shown in FIG. 3-1, the metalens 1 further includes a pattern layer 14. The pattern layer 14 is formed on the surface of the metastructure layer 12. In an implementation where a blue light-emitting diode is used as the incident light source, a metalens designed according to Equation (1) and having the pattern layer 14 can present a blue light pattern that is identical to what is shown in the pattern layer 14 at a far-field position matching the resonant light wavelength. In an implementation where a blue light-emitting diode is used as the incident light source, a metalens designed according to Equation (1) but lacking the pattern layer 14 can present a blue light pattern that is identical to the incident light source at a far-field position matching the metalens.

In addition, each metastructure 120 has its phase distribution following Equation (2):

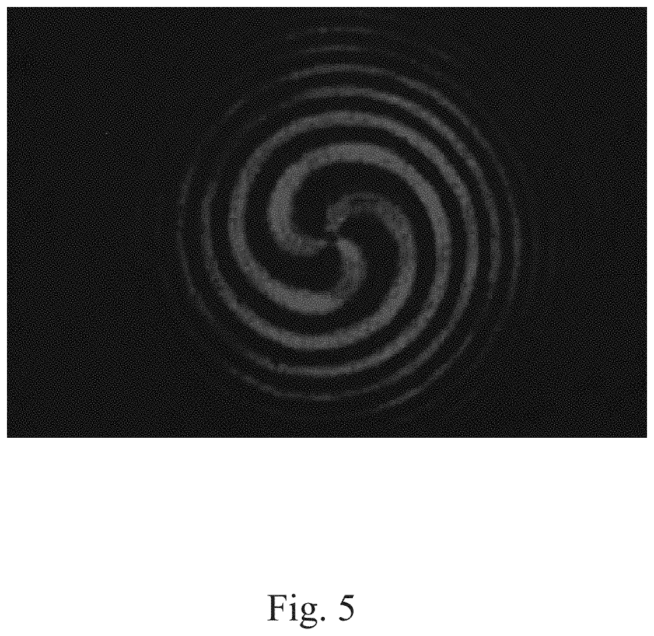

φ(r,θ)=k\sqrt{r²+f²+lθ} Equation (2)

where, r represents the relative polar coordinate with respect to the origin at the center of the surface of the metastructure layer, f represents the distance from the focal length of the metalens to the center of the surface of the substrate, θ represents the azimuthal angle, l represents the topological number of the angular momentum, and k represents the wave vector, so that the metalens presents a vortical light shape of the resonant light wavelength at a far-field position matching the resonant light wavelength (as shown in FIG. 5).

Accordingly, each metastructure 120 may further use different phase distribution equations for the light wavelength it resonates, so as to present different light shapes at the matching far-field position, or directly present a composite image. In the present invention, the phase distributions used by the metastructures 120 are not limited to what are defined by Equation (1) and Equation (2) as provided previously. In other words, any design that can compose different light shapes or present desired light patterns can be adopted by the metastructure 120 claimed by the present invention.

In the present invention, the metastructures 120 may be designed to resolve a wavelength of a red light, a green light or a blue light. Particularly, when the light source to be resolved is a blue light having a wavelength of 450-495 nm and a sub-wavelength of about 220-250 nm, and the diameter of the substrate 10 is 100 μm, then the focal length is 150 μm, the numerical aperture (NA) is 0.3, and the surface area radius r of each metastructure 120 is 28-76 nanometers.

Alternatively, if the light source to be resolved is a red light having a wavelength of 620-750 nm, and preferably 633 nm, and the diameter of the substrate 10 is 100 μm, then the focal length is 123 μm, and the numerical aperture (NA) is 0.4. Alternatively, if the light source to be resolved is a green light having a wavelength of 495-570 nm, and preferably 532 nm, and the diameter of the substrate 10 is 100 μm, then the focal length is 87 μm, and the numerical aperture (NA) is 0.57.

According to the present invention, where the resolved light source has a wavelength that is, for example, 450 nm, in order to produce a metalens 1 that has a lens diameter of 100 μm, a focal length of 150 μm, and a numerical aperture (NA) of 0.3, a gallium nitride (GaN) layer as thick as 800 nm has to be grown on sapphire (i.e., the substrate 10) through metal organic chemical vapor deposition (MOCVD). Then a silicon dioxide (SiO₂) layer as thick as 400 nm is deposited thereon. Afterward, a photoresist layer is applied over the silicon dioxide layer and exposed to electron beams. A chromium (Cr) layer of 45 nm is formed on the exposed photoresist layer by means of evaporation. Subsequently, the pattern of the metastructure 12 is transferred to the gallium nitride (GaN) layer through inductively coupled plasma-reactive ion etching (ICP-RIE) and the patterned GaN layer is immerged into buffer oxide etch, so as to complete production of the metalens 1.

The metastructure 120 has the radius r of its surface area vary with the light wavelength it resonates. The size of the radius r may be determined using simulation software, such as CST STUDIO SUITE.

The present invention provides a metalens set. As shown in FIG. 4, the metalens set 2 includes plural metalenses 1 that stacked together. The metastructures of the same metalens 1 may commonly resonate the same light wavelength. Alternatively, all metastructures in the metalens may be divided into a plurality of array groups that resonate different light wavelengths (as shown in FIG. 4-1). Further alternatively, all metastructures in the metalens may be divided into a plurality of array groups that resonate different light waves, and plural metalenses having such array groups are stacked so that the resonant light wavelengths of the array groups of different layers are arranged alternately (as shown in FIG. 4-2). FIG. 4 shows plural metalenses 1 that are stacked together, in which only the topmost metalens 1 is shown. The other metalenses 1 below the topmost metalens 1 present their respective light shapes or light patterns in far-field positions matching their respective resonant light wavelengths.

In the present invention, the metalens set 2 may have optical elements (such as polarizing plates, half-wave plates, or quarter-wave plates) or electronic components arranged between the metalenses 1, for further adjusting the light shapes or light patterns output by the metalens set 2 in terms of brightness, definition, or other optical properties.

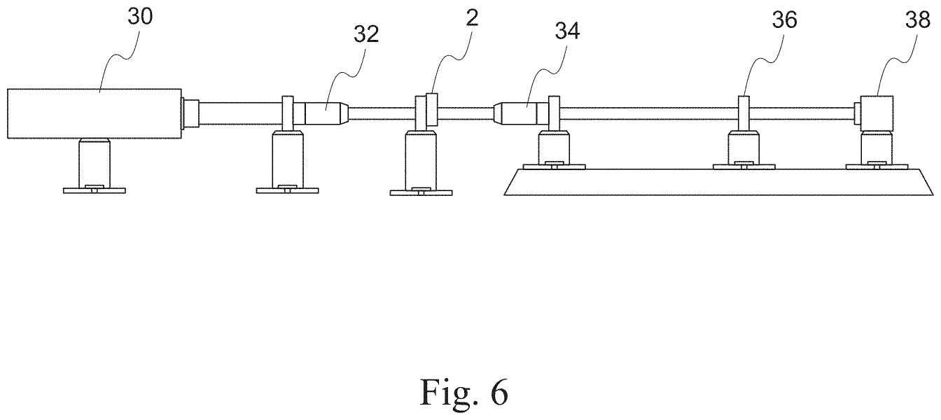

FIG. 6 illustrates the setting of an experiment in which a metalens set 2 presented light shapes or patterns at far-field positions matching its resonant light wavelengths. In the shown setting, the light source was a projector 30 lightened by light-emitting diodes. The light passed through a first optical element 32, the metalens set 2, a second optical element 34, and a third optical element 36 successively along the optical axis. Subsequently, the experiment used a camera 38 to capture the decrypted image. Therein, the first optical lens 32 and the second optical lens 34 were optically objective devices, while the third optical lens 36 was an optically attenuating element.

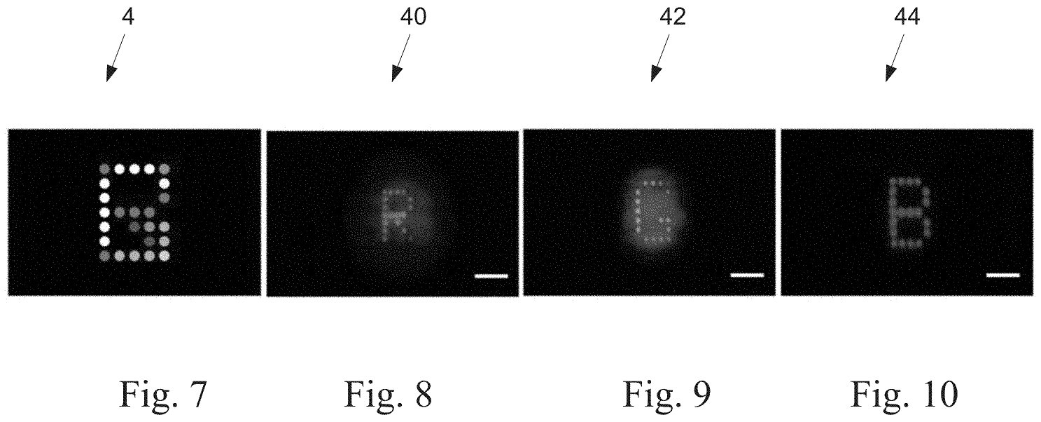

In an example related to a metalens set 2 composed of plural stacked metalenses 1, as shown in FIGS. 7-10, an overlay image 4 is composed of an image 40 shaped as an R of the red light wavelength, an image 42 shaped as a G of the green light wavelength, and an image 44 shaped as a B of the blue light wavelength that are stacked together. From the overlay image 4, the light wavelengths locationally overlap and mix to form different light wavelengths of different colors presented in the overlay image 4. For example, the image presented at the place where the red, green, and blue light wavelengths overlap each other is white. When the camera is located at different far-field positions, images of the resolved light sources of different light wavelengths can be presented, respectively. In the shown example, the focal lengths of the wavelengths of the red, blue, and green light sources are 150 μm, 123 μm, and 87 μm, respectively, for presenting the R-shaped image 40, the G-shaped image 42, and the B-shaped image 44, respectively.

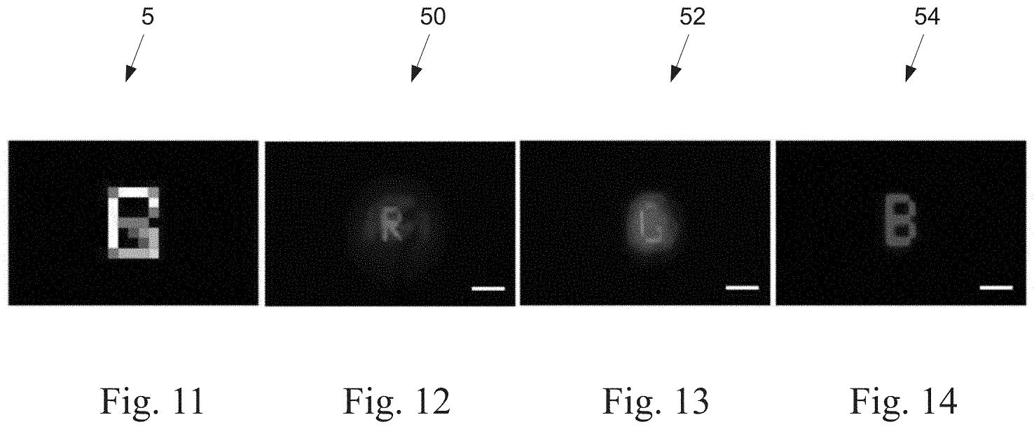

As shown in FIGS. 11˜14, another R-shaped image 50 of the red light wavelength, another G-shaped image 52 of the green light wavelength, and another B-shaped image 54 of the blue light wavelength overlap together to form an overlay image 5. From the different overlay image 5, the light wavelengths locationally overlap and mix together to form different light wavelengths of different colors presented in the overlay image 5. When the camera is moved to different far-field positions, images of resolved light sources of different light wavelengths can be presented, respectively. In this example, the focal lengths of the light wavelengths of the red, blue, and green light sources are 150 μm, 123 μm, and 87 μm, respectively, and another R-shaped image 50, another G-shaped image 52, and another B-shaped image 54 are presented, respectively.

As shown in FIGS. 15˜18, a rabbit image 60 of the red light wavelength, an orangutan image 62 of the green light wavelength, and a bear image 64 of the blue light wavelength are stacked to form yet another overlay image 6. From the yet another overlay image 6, the light wavelengths locationally overlap and mix together to form different light wavelengths of different colors presented in the yet another overlay image 6. When the camera is moved to different far-field positions, images of resolved light sources of different light wavelengths can be presented, respectively. In this example, the focal lengths of the light wavelengths of the red, blue, and green light sources are 150 μm, 123 μm, and 87 μm, respectively, and a rabbit image 60, an orangutan image 62, and a bear image 64, are presented, respectively.

Accordingly, the metalenses 1 designed for different light wavelengths may be stacked together to form a metalens set 2, and the metalens set 2 may be placed in front of a projector, so as to present images of resolved light sources of different light wavelengths at far-field positions of different light wavelengths. While images of the red light wavelength, the green light wavelength, and the blue light wavelength are described in the previous examples, practical implementations of the present invention are not limited thereto. In an alternative example, the metastructures in a metalens are divided into a plurality of array groups, each resonating a different light wavelength.

Since the metalens set 2 is placed in front of the projector, images of resolved light sources of different light wavelengths can be presented at far-field positions of different light wavelengths, and this phenomenon is applicable to image encryption and decryption, thereby providing a method of image decryption, which includes the following steps:
(S101) receiving an overlay image 4, which is composed of images of plural different light wavelengths overlapping each other; and
(S102) presenting, by the metalens set 2, the overlay image 4 as resolved light images at different far-field positions.

For example, an encrypted party may extract the colors of individual pixels in a secret military image as a red light wavelength image component, a green light wavelength image component, and a blue light wavelength image component, and mix this red light wavelength image component with the green and blue light wavelength image components in other images into a first overlay image, wherein the red light wavelength image component is a resolved image, and the green and blue light wavelength image components in other images are non-resolved images. Similarly, the green light wavelength image component is mixed with the red and blue light wavelength image components in other images into a second overlay image, wherein the green light wavelength image component is a resolved image, and the red a blue light wavelength image components in other images are non-resolved images. The blue light wavelength image component is mixed with the red and green light wavelength image components in other images into a third overlay image, wherein the blue light wavelength image component is a resolved image, and the red and green light wavelength image components in other images are non-resolved images.

Therefore, a decrypting party after receiving the first overlay image, the second overlay image, and the third overlay image, can obtain the red light wavelength image component, the green light wavelength image component, and the blue light wavelength image component at different far-field positions of the metalens set 2, and compose the red light wavelength image component, the green light wavelength image component, and the blue light wavelength image component together to recover the original secret military image. Of course, an encrypting party may further blend the first overlay image, the second overlay image, and the third overlay image into frames at non-continuous time points in a video clip. In this case, the decrypting party with the knowledge of at which time points the first overlay image, the second overlay image, and the third overlay image appear in the frames can do decryption as describe above.

Moreover, in the foregoing method of image decryption, the metalens set 2 is formed by stacking a plurality of metalenses 1 together. Every metalens 1 resonates a different light wavelength. Alternatively, the metastructures 120 in the metalens 1 are divided into a plurality of array groups, each of which resonates a different light wavelength. Alternatively, the metastructures 120 in a metalens 1 are divided into a plurality of array groups, each of which resonates a different light wave. Then the metalenses 1 having these array groups are stacked together, and every layer of the array groups in a metalens 1 have their resonant light wavelengths arranged alternately.

Additionally, in the foregoing method of image decryption, the overlay image 4 may be replaced by an incident light, which when received by the metalens set 2, is presented as a light shape or a light pattern at a far-field position matching the light wavelength the metalens set 2 resonates. The metalens set 2 may be formed by stacking a plurality of metalenses 1 together, and each metalens 1 resonates a different light wavelength. Alternatively, the metastructures 120 in the metalens 1 are divided into a plurality of array groups, each of which resonates a different light wavelength. Alternatively, the metastructures 120 in a metalens 1 are divided into a plurality of array groups, each of which resonates a different light wave. Then the metalenses 1 having these array groups are stacked together, and every layer of the array groups in a metalens 1 have their resonant light wavelengths arranged alternately. Therein, the incident light may be a light source of a single wavelength that can generate the light shape as shown in FIG. 5. Alternatively, the incident light may be an overlay image

In the present invention, the light source for each metalens 1 to resolve may be a linear polarized light, meaning that the metalens 1 can receive the light output by a projector directly, thereby being advantageous over the prior-art devices that can only receive s circular polarized light.

Additionally, a paper titled “Gallium Nitride Metalens for Image Decryption” published in the Crystals on Oct. 29, 2021; a paper titled “High-performance gallium nitride dielectric metalenses for imaging in the visible” published in the Scientific Reports on Mar. 22, 2021; and a paper titled “Polarization-insensitive GaN metalenses at visible wavelengths” published in the Scientific Reports on Jul. 15, 2021 are recited as evidence for the present application to claim priority rights. Each of these papers is herein incorporated by reference in its entirety.

Accordingly, the metalenses 1 designed for different light wavelengths present resolved light images at different far-field positions. When metalenses 1 designed for plural different light wavelengths are stacked together to form a metalens set 2, the metalens set 2 can present resolved light images of different wavelengths at different far-field positions at the same time. Thereby, the metalens set 2 can be used to decrypt an overlay image 4 formed by overlapped images of plural different light wavelengths.

The present invention has been described with reference to the preferred embodiments and it is understood that the embodiments are not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. A metalens, comprising:
a substrate; and
a plurality of metastructures, each having a shape designed to be related to a resonant light wavelength (λ) thereof;
in which, the metalens receives an incident light and presents a light shape or a light pattern of the resonant light wavelength at a far-field position matching the resonant light wavelength.

2. The metalens of claim 1, wherein the shape and a size of each said metastructure are such related to the resonant light wavelength that a surface area of the metastructure is related to the resonant light wavelength, and a height of the metastructure is related to the resonant light wavelength, while an interval between adjacent said metastructures is related to the resonant light wavelength.

3. The metalens of claim 1, wherein the height of the metastructure is equal to up to three times of the resonant light wavelength, with a height tolerance of ±30%.

4. The metalens of claim 3, wherein the interval between the adjacent metastructures is equal to a half of the resonant light wavelength, with an interval tolerance of ±30%.

5. The metalens of claim 4, wherein the surface area of the metastructure has a radius that is smaller than or equal to the interval of the metastructures.

6. The metalens of claim 1, wherein each of the metastructures has a phase distribution that follows an equation of:
$$φ ( x , y ) = \frac{2 π}{λ} ( f - \sqrt{{x}^{2} + {y}^{2} + {f}^{2}} )$$
wherein x and y are relative coordinates with respect to an origin located at a center of the substrate, f represents a distance from a focal length of the metalens to the center of the substrate, and λ represents a light wavelength of a resolved light source.

7. The metalens of claim 1, each of the metastructures has a phase distribution that follows an equation of
φ(r,θ)=k\sqrt{r²+f²+lθ}
wherein r represents a relative polar coordinate with respect to an origin located at a center of a surface of the substrate, f represents a distance from a focal length of the metalens to the center of the substrate, θ represents an azimuthal angle, l represents a topological number of an angular momentum, and k represents a wave vector.

8. A metalens set, comprising plural metalenses of claim 1, wherein the metalens are stacked together, and the metastructures of each said metalens commonly resonate an identical light wavelength.

9. A metalens set, comprising plural metalenses of claim 1, wherein all the metastructures of each said metalens is divided into a plurality of array groups, each of which resonates a different light wavelength.

10. A metalens set, comprising plural metalenses of claim 1, wherein all the metastructures of each said metalens is divided into a plurality of array groups, each of which resonates a different light wave, and the metalenses having these array groups are such stacked that the resonant light wavelength of every layer of the array groups of the metalens are arranged alternately.

11. A method of image decryption, comprising steps of:
receiving an overlay image, which is composed of image components of plural different light wavelengths overlapping each other; and
presenting the overlay image as respective resolved light images at different far-field positions using the metalens set of claim 8.

12. A method of image decryption, comprising steps of:
receiving an overlay image, which is composed of image components of plural different light wavelengths overlapping each other; and
presenting the overlay image as respective resolved light images at different far-field positions using the metalens set of claim 9.

13. A method of image decryption, comprising steps of:
receiving an overlay image, which is composed of image components of plural different light wavelengths overlapping each other; and
presenting the overlay image as respective resolved light images at different far-field positions using the metalens set of claim 10.

14. A method of light construction, comprising steps of:
using the metalens set of claim 8 to receive an incident light and present a light shape or a light pattern of the resonant light wavelength at a far-field position matching the resonant light wavelength.

15. A method of light construction, comprising steps of:
using the metalens set of claim 9 to receive an incident light and present a light shape or a light pattern of the resonant light wavelength at a far-field position matching the resonant light wavelength.

16. A method of light construction, comprising steps of:
using the metalens set of claim 10 to receive an incident light and present a light shape or a light pattern of the resonant light wavelength at a far-field position matching the resonant light wavelength.
